(19) United States
(12) Patent Application Publication
(10) Pub. No.: US 2010/0236428 A1
(43) Pub. Date: Sep. 23, 2010

(54) MULTI-PURPOSE DISCARDED MATERIAL TREATMENT SYSTEM

(75) Inventors: Stéphane Charlebois, St-Jerome (CA); Van Khieu, Ile-des-Soeurs (CA); Harold Hachey, Oka (CA)

Correspondence Address: BENOIT & COTE, s.e.n.c., 1001, DE MAISONNEUVE BOULEVARD WEST, SUITE 210, MONTREAL, QC, H3A 3C8, CA

(73) Assignee: VERSUN INC., Saint-Jerome (CA)

(21) Appl. No.: 12/602,020

(22) PCT Filed: May 23, 2008
(86) PCT No.: PCT/CA2008/000974

§ 371 Date: Jun. 3, 2010

Related U.S. Application Data
(60) Provisional application No. 60/940,248, filed on May 25, 2007.

(51) Int. Cl. B30B 9/30; B02C 19/00

(52) U.S. Cl. 100/102; 241/101.5

(57) ABSTRACT

The present document describes a multi-purpose discarded material treatment system. The material comprises organic waste and inorganic materials. The treatment system comprises a crusher adapted to receive the organic waste and to produce therefrom crushed organic material that exits the crusher. The treatment system further comprises a compactor adapted to receive inorganic materials and produce therefrom compacted inorganic materials that exit the compactor. The treatment system further comprises a housing on which are mounted the crusher and the compactor. The treatment system further comprises a cleaning system which is common to the crusher and the compactor. The cleaning system supplies a cleaning substance into each of the crusher and the compactor for cleaning purposes. Alternately, or in combination with the cleaning system, the treatment system comprises a hydraulic system which is common to the crusher and the compactor. The same hydraulic system is used for controlling the crusher and the compactor operation.

### CROSS-REFERENCE TO RELATED APPLICATIONS

This application claims priority under 35 USC §119(e) of U.S. provisional patent application 60/940248 filed May 25, 2007 and entitled “HOUSEHOLD RECYCLING UNIT”. For the United States National Phase, the specification of the foregoing provisional patent application is hereby incorporated by reference.

### TECHNICAL FIELD

This description relates to the field of recyclable material treatment systems. More particularly, this description relates to systems which are capable of treating many types of materials.

### BACKGROUND

The disposal of solid waste has become increasingly difficult for municipalities as landfills close down and environmental laws further reduce or eliminate options such as incineration. It has become increasingly obvious that recycling is the most viable alternative to conventional solid waste disposal procedures used in the past. Recycling offers an environmentally friendly means for disposing of solid waste while at the same time providing resources for manufactures of such as paper, plastic, glass, metal, compost, textile and so on, which are so critical to our daily lives.

Furthermore, one major problem of the actual recycling process is the cost of material separation. Waste management facilities cannot, or will not bear the cost of accurate material separation, for various reasons. A high percentage of recyclable materials are redirected to dump sites. Consumers do not wish to make the efforts required to separate recyclable materials by category. Consequently, the number of landfills continues to grow, natural resources are consumed quickly, and demanding recycling efforts go wasted.

The piled refuse usually resembles messy clutter or mounds of garbage, an undesirable sight to see, especially in a frequented area. The containers also easily overflow with the load of recyclable items and stay so several days. With time and temperature dirty waste develops many microbial activities. The overflowing items often intermingle, causing contamination of the recyclable materials, hazardous sanitary situation and unwanted smells.

Furthermore, households that aggressively sort their recyclables often become overwhelmed by bundles of papers and large bags of cans, glass and plastic bottles which have to be further separated depending on whether or not they required a deposit. Manually crushing plastic containers and cans is a hassle and inefficient and furthermore are not available on the market yet. These bags and bundles are then placed curbside where carters have to haul them to a recycling plant to process the waste products for recycling. The cost for hauling recyclables is sometimes overwhelming to the municipalities because of the unnecessary volume created by bottles, cans and the like that are in their original form resulting in a tremendous amount of the expense in carting recyclables coming from transporting the air contained in the containers. The cost for carting and processing these recyclables is then passed on to the consumer in the form of increased taxes.

Some of the references which characterize the prior art include the following patent(s) or patent application(s): U.S. Pat. No. 6,443,057, U.S. Pat. No. 5,619,914, U.S. Pat. No. 5,123,341, U.S. Pat. No. 4,102,263, US20060060586A1, US20060042197A1, U.S. Pat. No. 6,935,586, U.S. Pat. No. 6,903,142, U.S. Pat. No. 5,172,630, U.S. Pat. No. 7,000,532, U.S. Pat. No. 5,813,323, U.S. Pat. No. 5,259,304, U.S. Pat. No. 5,257,577. This listing of the prior art is not intended to be complete or to constitute an admission that it constitutes the closest prior art.

There is therefore a need to overcome at least one of the drawbacks mentioned above which include, but are not limited to: a substantial reduction in the volume of discarded materials, easily sorting a substantial amount of discarded material in a reduced space, reducing the foul smell associated with organic waste or dirty inorganic materials, reducing the noise and energy consumption associated with traditional treatment machines, simplifying and increasing reliability in comparison with traditional treatment machines, etc.

There is therefore a need for improvements in the field of recyclable material treatment systems starting from the source.

### SUMMARY

The present document describes a multi-purpose discarded material treatment system. The material comprises organic waste and inorganic materials. The use of the instant multi-purpose discarded material treatment system results in a reduction of up to 90% of the volume of recyclable material.

The treatment system comprises a crusher adapted to receive the organic waste and to produce therefrom crushed organic material that exits the crusher. The treatment system further comprises a compactor adapted to receive inorganic materials and produce therefrom compacted inorganic materials that exit the compactor. The treatment system further comprises a housing on which are mounted the crusher and the compactor. The treatment system further comprises a cleaning system which is common to the crusher and the compactor. The cleaning system supplies a cleaning substance into each of the crusher and the compactor for cleaning purposes. Alternately, or in combination with the cleaning system, the treatment system comprises a hydraulic system which is common to the crusher and the compactor. The same hydraulic system is used for controlling the crusher and the compactor operation.

Furthermore, the present document describes an embodiment for protrusions forming part of a compactor jaw. The protrusions are staggered on two opposing compactor jaws and are thereby adapted to alter the structure of the materials sufficiently for their volume to stay compressed after compaction. This is necessary for materials which have elastic memory such as certain types of plastic.

Additionally, the present document describes an embodiment for a crusher which functions at low speed and high torque. The crusher has spiraled angled rotating blades which pull in and crush organic waste including bones.

According to an aspect of the description, there is provided a multi-purpose discarded material treatment system. The material comprises organic waste and inorganic materials. The treatment system comprises a crusher having crushing means and a crusher cleaner means. The crushing means is adapted to produce, from the organic waste, crushed organic material. The treatment system further comprises a compactor having compactor means and a compactor cleaner means. The compactor means is adapted to produce, from the inorganic materials compacted inorganic materials. The treatment system further comprises a cleaning system having connections to the crusher cleaner means and the compactor cleaner means. The cleaning system for supplying, through the connection, a cleaning substance into each of the crusher and the compactor for cleaning purposes. The treatment system further comprises a housing on which are mounted the crusher, the compactor and the cleaning system.

According to another aspect of the description, there is provided a multi-purpose discarded material treatment system. The material comprises organic waste and inorganic materials. The treatment system comprises a crusher having crushing means and crusher actuating means. The crushing means is adapted to produce, from the organic waste, crushed organic material. The crusher actuating means for connectively controlling the crushing means. The treatment system further comprising a compactor having compactor means and compactor actuating means. The compactor means adapted to produce, from the inorganic materials, compacted inorganic materials. The compactor actuating means for connectively controlling the compactor means. The treatment system further comprising a hydraulic system having hydraulic lines connected to the crusher actuating means and to the compactor actuating means. Both the crusher actuating means and the compactor actuating means for being controlled using hydraulic fluid in the hydraulic lines. The treatment system further comprising a housing on which are mounted the crusher, the compactor and the hydraulic system.

According to another embodiment, there is provided the use of the treatment systems described above.

According to another embodiment, there is provided a method for treatment of discarded materials comprising organic waste and inorganic materials. The method comprises: providing a crusher, a compactor and a cleaning system within a single housing; the crusher receiving the organic waste and producing, from the organic waste, crushed organic material; the compactor receiving the inorganic materials, and producing, from the inorganic materials, compacted inorganic materials; and the cleaning system alternately or simultaneously supplying a cleaning substance into each of the crusher and the compactor for cleaning purposes.

According to another embodiment, there is provided a method for treatment of discarded materials comprising organic waste and inorganic materials. The method comprises: providing a crusher, a compactor and a hydraulic system within a single housing; the crusher receiving the organic waste and producing, from the organic waste, crushed organic material; the compactor receiving the inorganic materials, and producing, from the inorganic materials, compacted inorganic materials; and the hydraulic system alternately or simultaneously controlling the crusher and the compactor and hence the production of crushed organic material and the production of compacted inorganic materials.

According to another embodiment, there is provided a compactor comprising: a compactor input, a compactor output, compactor jaws, and compactor actuating means. The compactor input adapted to receive inorganic materials. The compactor jaw adapted to produce, from the inorganic materials compacted plastic, compacted metal, compacted glass, compacted cardboard and compacted inorganic materials that exits the compactor through the compactor output. The compactor actuating means for connectively controlling the compactor jaw position. The compactor jaw comprises v-shaped protrusions. The dimensions of the v-shaped protrusions are determined by experimentation to optimize the results: least energy used, most all materials compacted, most structural resiliency of plastic broken, most safely operated, most easily waste get out the jaws.

According to another embodiment, there is provided a crusher adapted to produce, from organic waste, crushed organic material. The crusher comprises a cylindrical body and blades mounted on rotatable shaft within the cylindrical body. The rotatable body having a crusher input and a crusher output. The crusher input adapted to receive the organic waste. The crushed organic material exits the crusher through the crusher output. The blades are mounted on an angle whereby upon rotation of the rotatable shaft the organic waste is pulled in to the crusher input and the crushed organic material is pushed within the cylindrical body to the crusher output.

### BRIEF DESCRIPTION OF THE DRAWINGS

Further features and advantages of the present invention(s) will become apparent from the following detailed description, taken in combination with the appended drawings, in which:

FIG. 1 is an isometric schematic view of a multi-purpose discarded material treatment system according to an embodiment of the invention(s);

FIG. 2a is a section view of the crushing means according to an embodiment of the invention(s);

FIG. 2b is an isometric schematic view of the cylindrical body of the crusher, including an input and an output according to an embodiment of the invention(s);

FIG. 2c is an isometric schematic view of the blade assembly of the crusher according to an embodiment of the invention(s);

FIG. 3 is a front schematic showing an overview of the processing treatment of organic waste from the sink to the dedicated receptacle according to an embodiment of the invention(s);

FIG. 4 is an isometric schematic showing an overview of the compactor according to an embodiment of the invention(s);

FIG. 5a is a top view partially showing the compactor jaws comprising v-shaped protrusions according to an embodiment of the invention(s);

FIG. 5b is an isometric schematic view showing the compactor jaws comprising v-shaped protrusions according to an embodiment of the invention(s);

FIG. 6 is a flow diagram of the cleaning system, including drains, according to an embodiment of the invention(s);

FIG. 7 is a flow diagram of the hydraulic power system according to an embodiment of the invention(s);

FIG. 8 is the block diagram describing functions and architecture of the control device according to an embodiment of the invention(s);

FIG. 9 is a flow chart of a multi-purpose discarded material treatment method according to an embodiment of the invention(s);

FIG. 10 is a flow chart of a multi-purpose discarded material treatment system according to another embodiment of the invention(s); and

FIG. 11 is a section view of the knife assembly according to an embodiment of the invention(s).

It will be noted that throughout the appended drawings, like features are identified by like reference numerals.

### DETAILED DESCRIPTION

Definitions: In the present description, the following definitions apply:
“inorganic materials” is meant to include plastic, metal, glass, cardboard, paper, textile etc.
“organic waste” is meant to include food waste, etc.
“cleaning substance” is meant to include water, water with soap or another cleaning agent, gaseous substances, etc.
“compactor jaw” or “compactor jaws” is meant to include arrangement of one or two moving parts. The moving parts may include facing plates. The definition also includes arrangement where one part is fixed and the other is movable.

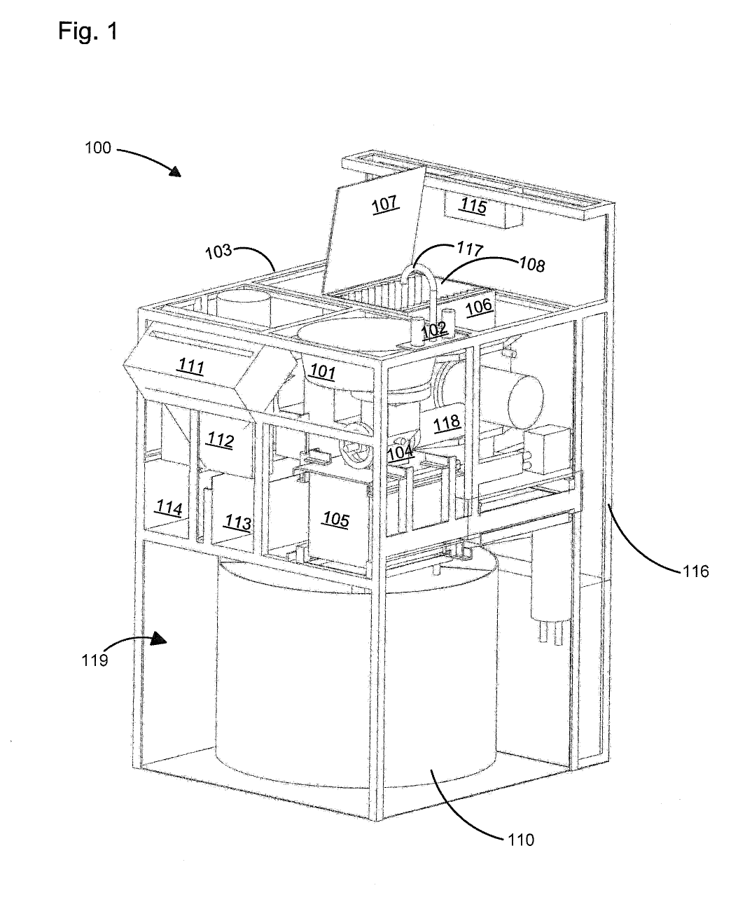

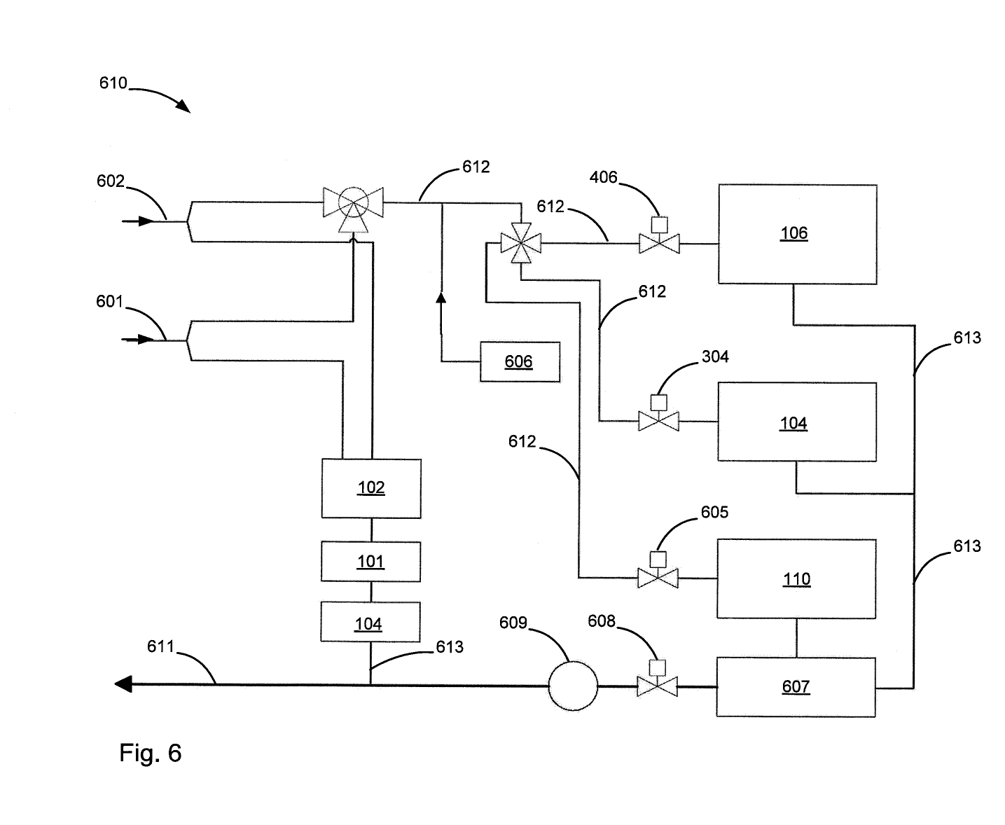

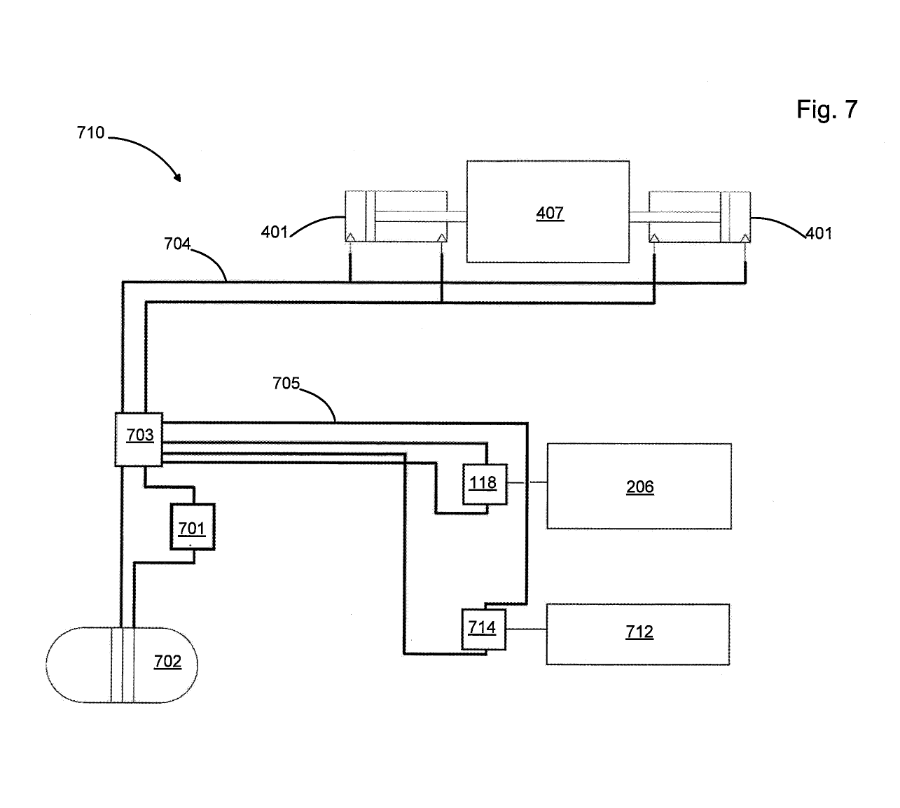

Referring now to the drawings, and more particularly to FIG. 1, an isometric diagram illustrates a material treatment system 100 according to an embodiment. The treatment system 100 as illustrated, comprises a housing 100, a sink 101, one or more openings 108, a compactor 106, a crusher 104, a shredder 111, a transfer device 112, storage bins 110, organic material receptacle 105, a cleaning system 610 (not shown on FIG. 1, but detailed on FIG. 6), a central power unit 701 (not shown on FIG. 1, but detailed on FIG. 7), a hydraulic system 710 (not shown on FIG. 1, but detailed on FIG. 7), a user interface panel and control device 115. The user interface panel and control device 115 are shown in a single package, but the user interface panel and the control device could be located in different portions of system 100.

In this embodiment, the housing 103 comprises a frame 116 covered with sheet metal or a composite body envelope. In this embodiment, the compactor 106, the crusher sink 101 and the interface panel 115 are shown fixed to the frame 116. In another embodiment, the parts of the treatment system 100 could be fixed upon a self-standing body.

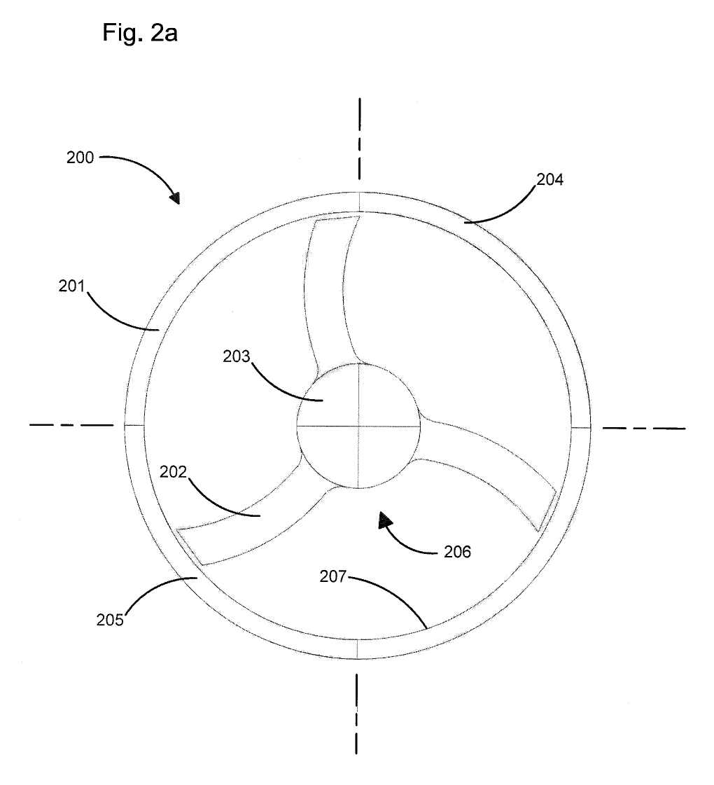

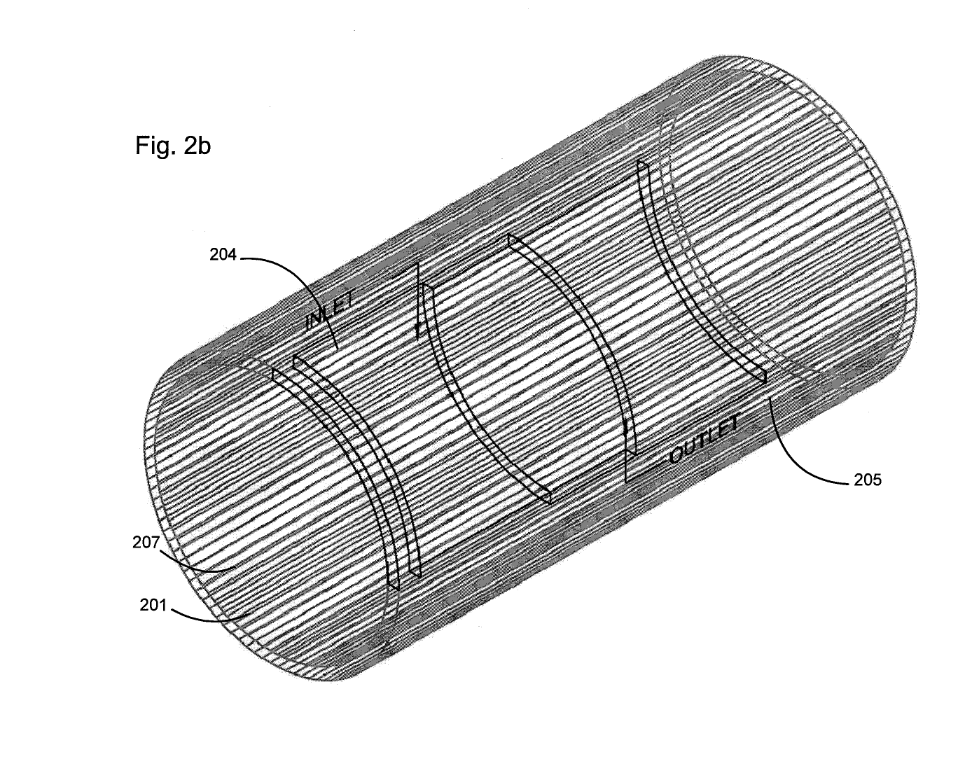

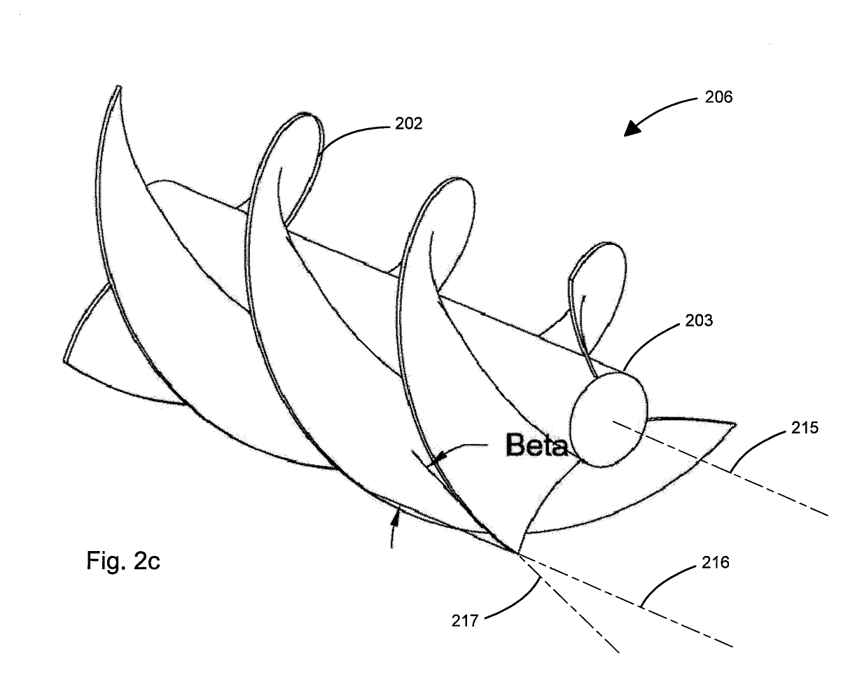

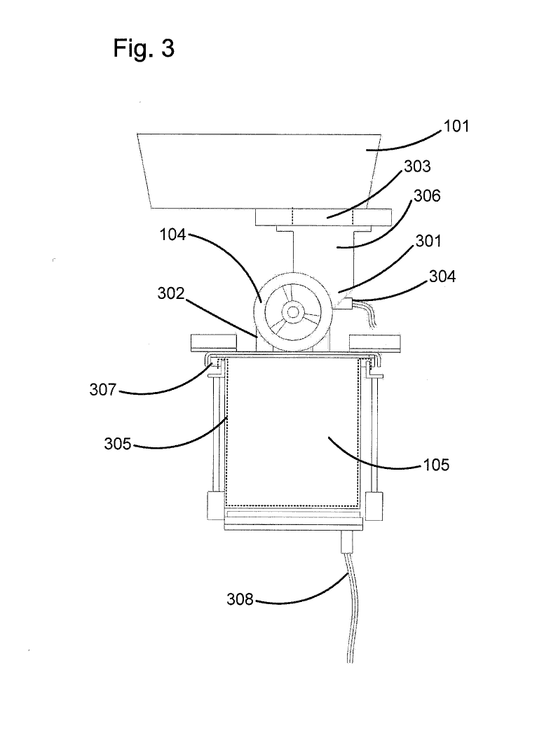

Still referring to FIG. 1, there is shown a multi-purpose discarded material treatment system 100. The treatment system 100 comprises a crusher 104 having a crusher input 301 (FIG. 3), a crusher output 302, crushing means 200 (FIG. 2), and a crusher cleaner input 304. The crusher cleaner input 406 is the input to a crusher cleaner means (not shown) that is used in the cleaning of the crusher 104. The crusher input 301 is adapted to receive the organic waste. The crushing means 200 is adapted to produce, from the organic waste, crushed organic material which exits the crusher 104 through the crusher output 302. The crusher cleaner means may include a spray nozzle, brushes or any other means that may be useful for cleaning purposes.

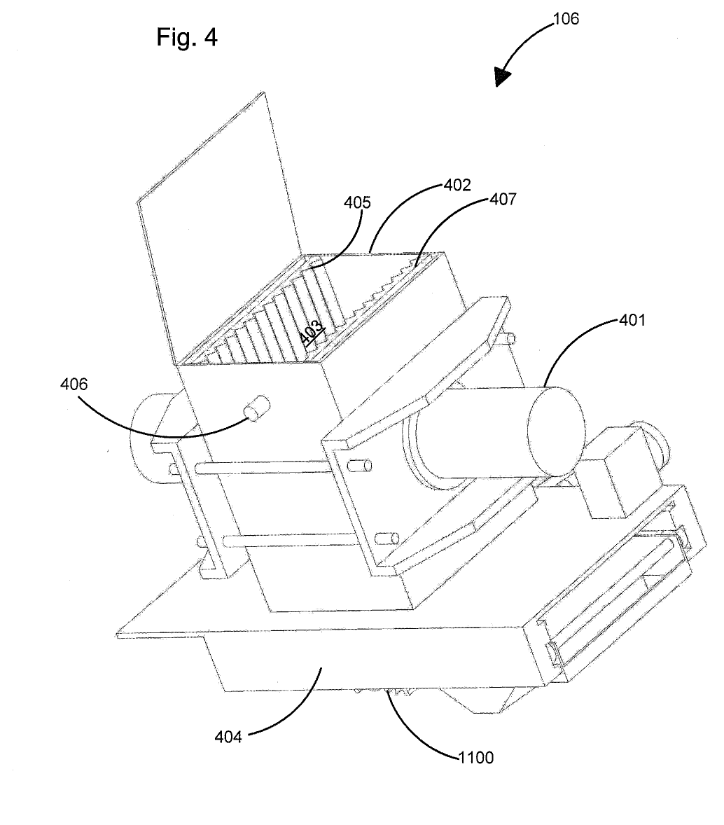

The treatment system 100 further comprises a compactor 106 having a compactor input 403 (FIG. 4), a compactor output 404, a compactor jaw 407, and a compactor cleaner input 406. The compactor cleaner input 406 is the input to a compactor cleaner means (not shown) that is used in the cleaning of the compactor 106. The compactor input 403 is adapted to receive inorganic materials. The compactor 106 is designed to produce, from the inorganic materials, compacted inorganic materials that exit the compactor 106 through the compactor output 404. The treatment system 100 further comprises a cleaning system 610 (FIG. 6) connected to the crusher cleaner input 304 (FIG. 3) and the compactor cleaner input 406 (FIG. 4). The cleaning system 610 for supplying a cleaning substance into each of the crusher 104 and the compactor 106 for cleaning purposes. The treatment system 100 further comprises a housing 103 on which are mounted the crusher 104 and the compactor 106.

Again referring to FIG. 1, and according to another aspect, the crusher 104 has crusher actuating means 118 for connectively controlling the crushing means 200 (FIG. 2). The compactor 106 has compactor actuating means 401 for connectively controlling the compactor jaw. The treatment system 100 further comprises a hydraulic system 710 (FIG. 7) having hydraulic lines 704-705 connected to the crusher actuating means 118 and to the compactor actuating means 401. Both the crusher actuating means 118 and the compactor actuating means 401 for being controlled by variations in hydraulic fluid in the hydraulic lines 704-705 using valves 703.

Now referring to FIG. 3, there is shown the processing treatment of organic waste from the sink to the dedicated receptacle 105.

The sink 101 receives every kind of organic waste and concentrates them to its bottom. Hot and cold water is provided to clean vegetables, hands, pots, etc. In the embodiment shown in FIG. 3, the water is provided through a faucet 102 with a spout 117. In another embodiment, the sink 101 could be a single or a double sink also equipped with faucets.

At the bottom of the sink 101, a hole 303 and a conduit 306 provide a passage for the organic waste to the low speed crusher input 301. Water flow from the sink 101 is useful to drain the materials. A sink magnetised cap may be used for safety reasons or any other means adapted for the same purpose.

Now turning to FIG. 2a, there is shown a crushing means 200 comprising a cylindrical body 201 and blades 202 mounted on rotatable shaft 203 within the cylindrical body 201. The cylindrical body 201 having a crusher input 204 and a crusher output 205. The crusher input 204 adapted to receive the organic waste. The crushed organic material exits the crusher through the crusher output 205. The blades 202 are designed with a spiraled angle whereby upon rotation of the rotatable shaft 203 the organic waste is pulled into the crusher input 204 and the crushed organic material is pushed within the cylindrical body 201 toward the crusher output 205. The spiraled angle of the blades 202 can be any angle between 15 degrees to 45 degrees, more specifically between 20 and 40 degrees, or even more specifically between 25 and 35 degrees. The spiraled angle is defined as the angle between a direction in the axis of rotation of the shaft 203 and a tangent to any one of the blade tips while looking at the blade assembly 206 in a direction that is perpendicular to the axis of rotation. The spiraled angle of the blade may vary from one end to the other for increased crushing effect. Also, different blade arrangements are possible at the input and the output of the crusher. For example, a single blade at the input and more that one blade at the output or two blade assemblies mounted on separate shaft turning at different speeds at the input and the output.

Still referring to FIG. 2a, there is shown a section view of the low rotating speed crushing means 200. On the upper right side of crushing means 200, organic waste is received in the body 201 through the input opening 204. In the embodiment shown in FIG. 2, the body 201 has a substantially tubular shape. Inside the body 201, a blade assembly 206 comprising blades 202 is driven by crusher actuating means 118 such as a hydraulic engine or by any other means know to a person skilled in the art such as mechanical, electromagnetic or thermodynamic means (like a Sterling engine, for example). FIG. 2b shows an embodiment with three blades 202. Other possible embodiments include one or more blades.

The organic waste is crushed by the interaction of the blades 202 with the input opening 204 and is also moved by the blades 202 against the inside surface 205 of body 207. The organic waste travels inside the body 207 until it reached to the crusher output 205. It is understood that organic waste is pulled, pushed and crushed repeatedly by the successive blades. On the bottom left of crusher 200, crushed waste is released by gravity through the crusher output 205 and falls into a receptacle 105. On the bottom inside of the conduit 306 there may be a screen with a water bypass (not shown) through which flows out the excess water to the drain 308.

Blade assembly 206 rotates about a rotation axis 203 at a generally slow speed with high torque. The speed range may be between 30 rpm and 120 rpm, more specifically between 60 rpm to 90 rpm, while the torque may vary proportionately to the input power.

The distance between the blade 202 and the body 201 may be comprised between 0.5 mm to 1 mm. No sharpening is necessary neither for the blades 202 nor for the body 201. The input opening angle is shown to be 90 degree upward from horizontal. In other embodiments, the input opening angle can be up to 180 degrees from horizontal. The output opening angle a can be from 90 to 120 degrees. This is beneficial to reduce the vertical space occupied by the crusher 104 (FIG. 1); that is, feeding the organic waste directly at the top of body 201 would result in occupying more space vertically. This arrangement maximizes the height available for the lower bins 110.

The receptacle 105 is set on gliding rails 307 to easily pull it out of the body 103 when it is full.

FIG. 2b shows the cylindrical body 207 of the crusher 104, including an input 301 and an output 302 according to an embodiment of the invention.

FIG. 2c shows the blade assembly 206 of the crusher 104 according to an embodiment of the invention.

Now returning to FIG. 3, a bag 305, made of biodegradable material according to an embodiment, is shown lining the organic trash receptacle 105. When a bag 305 is full, the user pulls out the full bag 305 and puts in a new one. These bags are porous and the receptacle 105 is perforated so that water is let through the receptacle to join the drain network 308.

Now returning to FIG. 1, there is shown an embodiment wherein the compactor opening 108 is on the top of the housing 103 to maximize the space utilisation, with a cover 107 equipped with a locking device to prevent users from being injured. This arrangement allows feeding of materials into chamber 403 of compactor 106. In another embodiment, the opening 107 of compactor 106 could be on a vertical face of the housing 103.

Details of the compactor 106 are shown on FIG. 4. One of the functions of the compactor 106 is to structurally alter or break the materials it receives. The structure of the materials should be sufficiently altered so that their volume is reduced after compaction. This is necessary for materials which have elastic memory such as certain types of plastic. The compactor 106 comprises two jaws 407 facing each other. At least one of the jaws 407 may be moved toward the other by one or more compactor actuating means 401 such as hydraulic cylinders. The volume is closed on the sides by a container 402. In another embodiment, the compactor actuating means 401 could be screws or other mechanical, electromagnetic or thermodynamic means and the axis of compression can be vertical or otherwise.

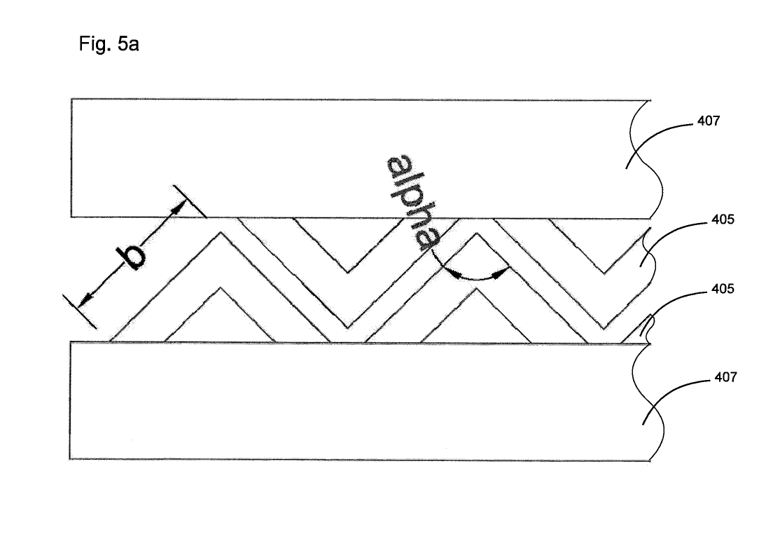

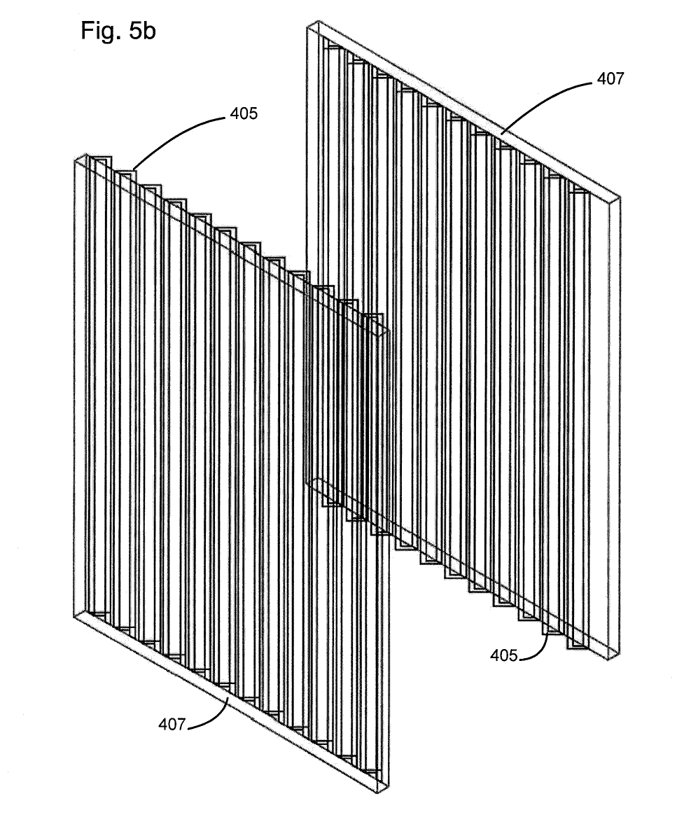

Now referring to FIG. 5b, there is shown compactor jaws 407 comprising compactor actuating means 401 for connectively controlling the compactor jaws 407. The compactor jaws 407 comprising v-shaped protrusions 405. Referring to FIG. 5a. The dimensions of the v-shaped protrusions 405 are determined by calculation completed by experimentation where alpha can be between 45 to 120 degrees, and dimension (b) can be between 5 mm to 20 mm.

As shown on FIGS. 5a and 5b, v-shaped protrusions 405 are fixed to, or form part of the jaws 407. The profile of the v-shaped protrusions 405 according to an embodiment is shown on FIGS. 5a and 5b. The v-shaped protrusions 405 are staggered to increase material deformation and efficiency of the compactor 106. In another embodiment, the v-shaped protrusions 405 are fixed to only one of the jaws 407. The protrusions may also assume shapes which are different from that shown in FIGS. 5a and 5b.

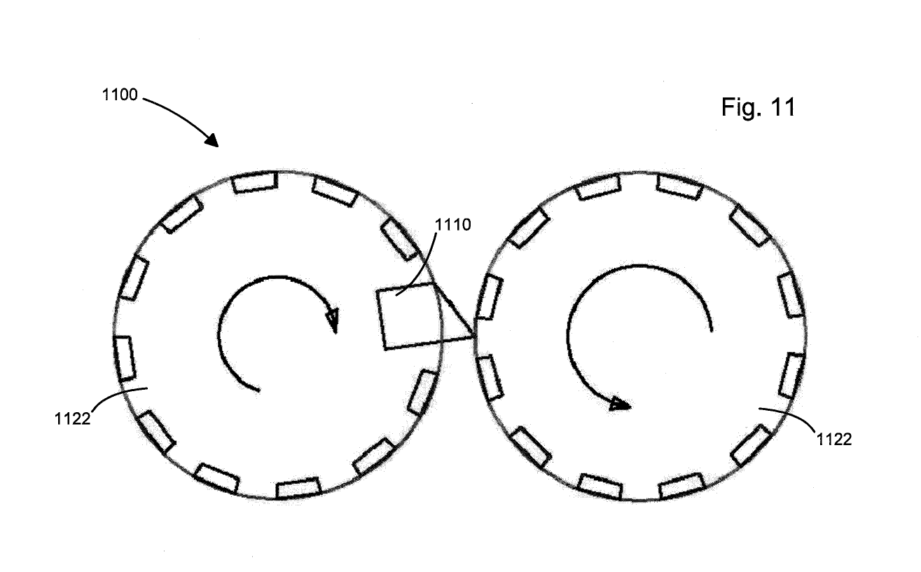

As shown in FIG. 11, system 100 may also be fitted with a knife assembly 1100 at the output 404 of the compactor 106 for cutting the inorganic materials to which it is applicable (e.g., plastic, paper, cardboard, etc.). The knife assembly 1100 may include a knife blade 1110 on a roller 1122. Another roller 1120 interacts with roller 1122 to pull and cut the inorganic materials. In another embodiment, one or both rollers 1120, 1122 are movable in order to let through the inorganic materials which do not need (or cannot) be cut.

Such an arrangement makes it possible to break and compress inorganic materials. For enhanced performance, an option includes heating the v-shaped protrusions prior or during compression. Another option, could be to wet the material to be compressed. The profile shown on FIGS. 5a and 5b makes it easy to separate the compressed waste from the protrusions. Also, the protrusions 407 do not need to be sharpened. A non-stick coating may be used for treating some specific materials.

According to this embodiment, when the compression cycle is over, jaws 407 are separated and compressed materials fall directly into a selected one of the bins 110. Previously, the control device will have rotated the lower table to place the selected receptacle below the compactor output 404.

In another embodiment, the compactor 106 could be equipped with a binding baling system. When the chamber 403 of the compactor 106 is full of compacted materials such as compacted plastic, paper, cardboard, textile or other material, the bounding bailing system groups the ball with ties such as string, tie wrap, wire or any other suitable tying means. The balls could be manually pulled out of the chamber and easily moved.

Now returning to FIG. 1, there is shown conventional shredder module 111 for treating paper or cardboard. Shredded materials slip on a fall 112 toward a specific receptacle 113. This receptacle is on sliding rails. The slot 114 is available as supplementary storage for materials like paper, batteries or for other uses.

As shown on FIG. 1, the lower part 119 is reserved for the rotating bins 110. Bins 110 are fixed on a rotating table 712. Each bin 110 is separately secured to the table 712 with a quick lock (not shown) and can be easily removed to empty it. The rotating motion is provided by a rotating means such as an electrical engine (not shown) via direct drive, a belt, a chain or other means.

In other embodiments, the rotating means could be a hydraulic engine or a hydraulic cylinder system, or an electromagnetic or thermodynamic device (not shown).

Now turning to FIG. 7, there is illustrated the hydraulic power system 710 of this embodiment. A central hydraulic power unit 701, preferably low pressure, fills a sealed tank 702 to get a sufficient autonomy to work without the pump 701 running. Tank 702 provides a plurality of motion media such as hydraulic cylinders 401, hydraulic motor 118, and hydraulic motor 714 to move respectively the jaws 407, the blade assembly 206, the rotating table 712 and other equipment via a solenoid valve system 703. Use of hydraulic power reduces the noise level of treatment system 100 during operation. The pump 701 could be controlled by an electrical engine or other mechanical, electromagnetic or thermodynamic means. The overall hydraulic system 710 is controlled by the control module 800.

Now turning to FIG. 6, there is illustrated the cleaning system 610 according to an embodiment. The cleaning system 610 is for cleaning the discarded material, for removing any remaining materials, for killing any possible microbial activity and hence for preventing foul smells. Cold water 601 and hot water 602 are provided at faucets 102 in the sink 101 and may also be provided in the cleaning system 610. The cleaning system 610 comprises a tempered water distribution system with a controlled soap or/and other chemical product concentration device 606, hence providing a cleaning solution. The cleaning solution is piped separately to the compactor cleaner input 406, the crusher cleaner input 304 and the storage container cleaner input 605 through connections 612. The cleaning system 610 of the compactor 106 is for cleaning the compactor 106 and for cleaning the materials under control of the user interface panel and control device 115.

Referring to FIG. 6, a large holding tank 607, located at a low point of system 100, receives waste water from any of the drains of the washing system 610. A level sensor 608 senses when the holding tank 607 is full and a pump 609 sends the waste water to the main drain 611. Waste water is drained to the large holding tank 609 from compactor 106, crusher 104 and bins 110 through piping 613.

Now returning to FIG. 1, there is shown the user interface panel 115 according to an embodiment. The panel 115 comprises a screen (not shown), buttons (not shown) or other user interface means (e.g., ball, mouse, touch-screen, voice interaction means, etc.) to show output information and receive input information useful for different kinds of user (responsible, young, old, blind, etc.), for maintainers, for trouble-shooters, etc.

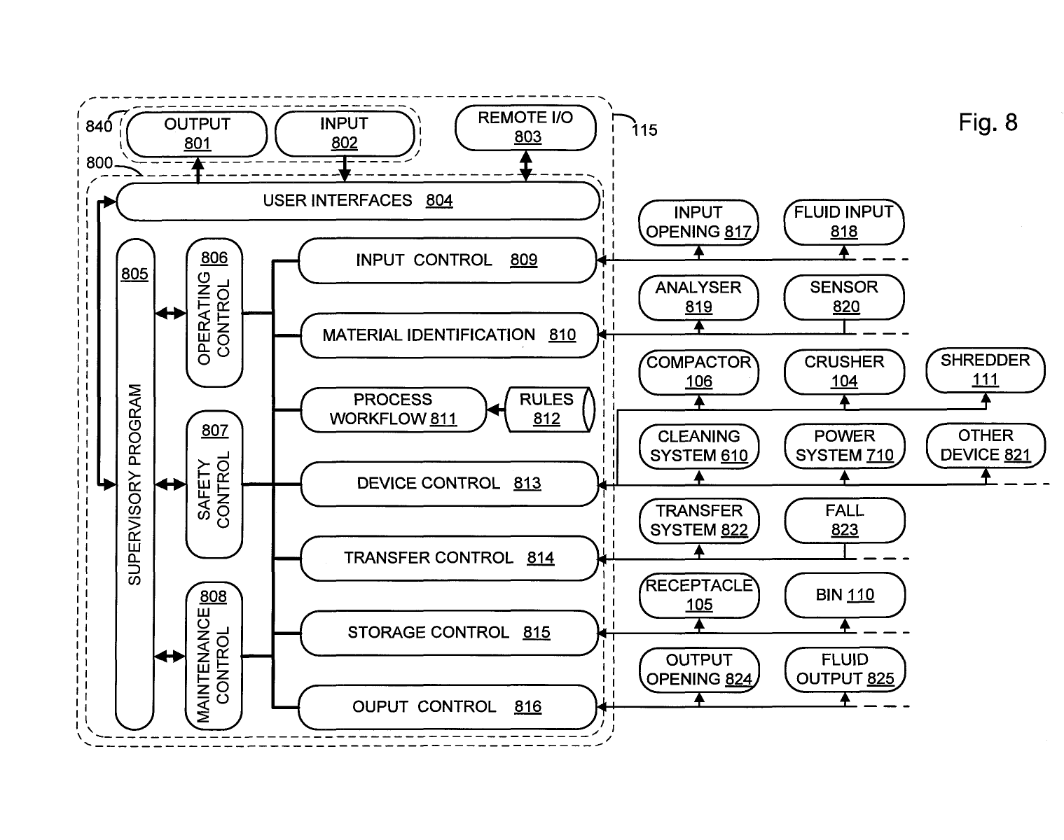

Now turning to FIG. 8, there is shown a block diagram describing functions and architecture of the user interface panel and control device 115. The user interface panel and control device 115 comprises a user interface panel 840 and a control device 800. The user interface panel 840 and the control device control 800 can be located in different portions of system 100.

The user interface panel 840 is a bi-directional communication media between the system 100 and any kind of users. The user interface panel 840 comprises output means 801 and input means 802. This interface panel 840 can be mounted on the system 100 or simply in the vicinity of system 100, i.e., in the same room.

The control device 800 comprises four levels of control.

The first level of control comprises user interfaces 804 which control communications between the control device 800 and the users as described previously. Users could communicate with the system 100 via the user interface panel 840 and/or via a remote means connected on the remote I/O 803. These remote means could be a specific movable box or could be other standard user interface panels connected with networks as internet, local network, building network. The connection between the remote I/O 803 and remote means could be with wire, radio wave, infrared light, etc.

The second level of control of the control device 800 comprises a supervisory program 805 which coordinates the operating control 806, the safety control 807 and the maintenance control 808 control with the user interfaces 804.

The third level of control of the control device 800 comprises an operating control 806, a safety control 807 and a maintenance control 808. The operating control 806 controls every device with operating purposes. Operating purposes are to input, to sort, to clean, to compress, to store and to output organic waste and inorganic materials. The safety control 807 controls every device with safety purposes. Safety purposes are to prevent any user from injuring themselves and attacking their integrities and to prevent the environment form disturbing with noise, water, heat, electricity, vibration, smell. The maintenance control 808 controls every device with maintenance purposes. Maintenance purposes are to prevent any equipment of the system 100 from troubleshooting and/or breaking. The operating control 806, safety control 807 and maintenance control 808 communicate with the advisory program to get instructions and to report status.

The fourth level of control of the control device 800 comprises the input control 809, the material identification 810, the workflow process 811, the device control 813, the transfer control 814, the store control 815 and the output control 816. The verb “control” means to send actuating information to the actuating means of the controlled system after a treatment of information received from sensors of the controlled system and instructions received form outside with a specific program.

The input control 809 controls the input openings 817 and fluid input 818. The input openings could be only monitored or actuated as well.

The material identification 810 identifies the material in combination with user instructions and with information coming form sensor 820 via analyser 819. Analyser 819 could be an ultrasonic analyser, a chromatograph analyser, an infrared analyser, a ray analyser, a thermo analyser, a spectrometer analyser, or a barcode reader.

The process workflow 811 sets the effective process workflow for the identified material from instructions of the second level of control of the control device 800 and from a database of rules 812.

The device control 813 controls the compactor 106, the crusher 104, the shredder 111, the cleaning system 610, the power system 710 and any other device 821.

The transfer control 814 controls any transfer system 822 as fall 823, mechanical system, continuous belt system, air bowed system or others means including the control of splitting transfer system.

The storage control 815 controls receptacle 105 and bin 110 and other means to store material. Especially the level of fullness is reported and the position of movable bins is controlled.

The output control 816 controls the output opening 824 and fluid output 825.

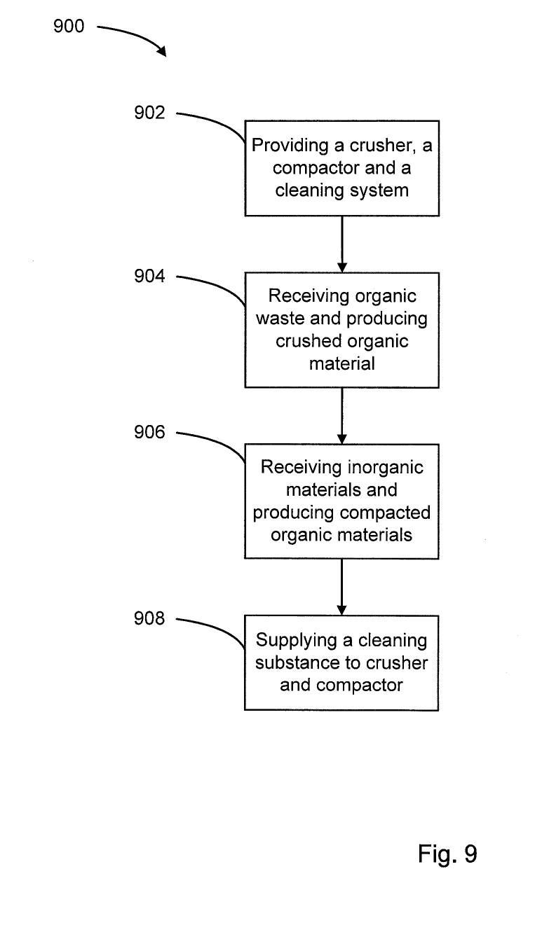

FIG. 9 is a flow chart of a method 900 for treatment of discarded materials comprising organic waste and inorganic materials according to an embodiment of the invention(s). The method comprises: providing a crusher, a compactor and a cleaning system within a single housing (step 902); the crusher receiving the organic waste and producing, from the organic waste, crushed organic material (step 904); the compactor receiving the inorganic materials, and producing, from the inorganic materials, compacted inorganic materials (step 906); and the cleaning system alternately or simultaneously supplying a cleaning substance into each of the crusher and the compactor for cleaning purposes (step 908).

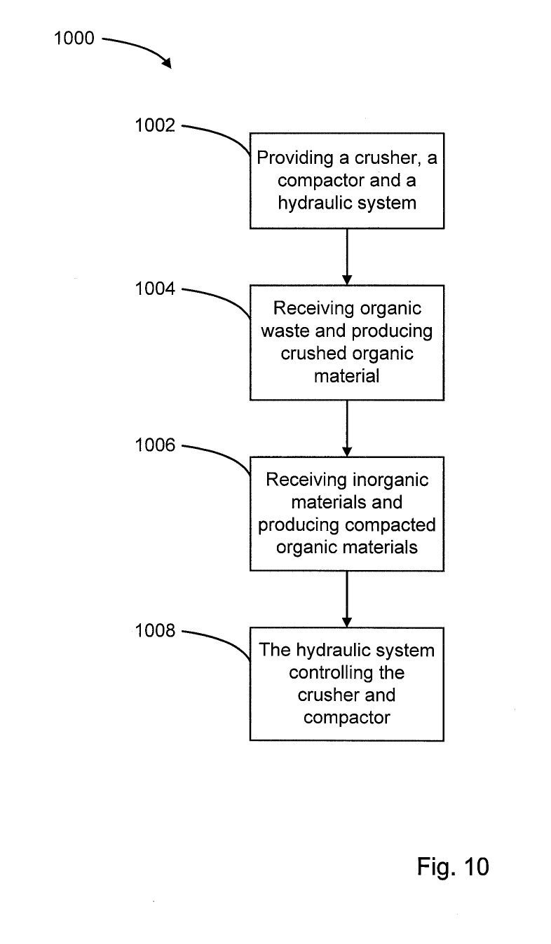

FIG. 10 is a flow chart of a method 1000 for treatment of discarded materials comprising organic waste and inorganic materials according to an embodiment of the invention(s). The method comprises: providing a crusher, a compactor and a hydraulic system within a single housing (step 1002); the crusher receiving the organic waste and producing, from the organic waste, crushed organic material (step 1004); the compactor receiving the inorganic materials, and producing, from the inorganic materials, compacted inorganic materials (step 1006); and the hydraulic system alternately or simultaneously controlling the crusher and the compactor and hence the production of crushed organic material and the production of compacted inorganic materials (step 1008).

The following text describes an example of use of the treatment system described herein. A prototype treatment system was used over a period of at least one week with a discarded materials composed of aluminium, cardboard, glass, paper, plastics and steel. The average recycling of such discarded materials for an average family in Quebec is 30%. With the use of the system, a recycling of 85% of the discarded material was achieved with a reduction in volume, as compared to traditional recycling, of more than 80%.

While preferred embodiments of the invention have been described above and illustrated in the accompanying drawings, it will be evident to those skilled in the art that modifications may be made therein without departing from the essence of this invention. Such modifications are considered as possible variants comprised in the scope of the invention.

1. A multi-purpose discarded material treatment system, the discarded material comprises organic waste and inorganic materials, the treatment system comprising:
a. a crusher having crushing means and crusher cleaner means, the crushing means adapted to produce, from the organic waste, crushed organic material;
b. a compactor having a compactor means and a compactor cleaner means, the compactor means adapted to produce, from the inorganic materials, compacted inorganic materials;
c. a cleaning system having connections to the crusher cleaner means and the compactor cleaner means, the cleaning system for supplying, through the connection, a cleaning substance into each of the crusher and the compactor for cleaning purposes; and
d. a housing on which are mounted the crusher, the compactor and the cleaning system.

2. The treatment system of claim 1, wherein the housing comprises two housing openings, each housing opening providing a passageway to a corresponding one of the crusher input and the compactor input.

3. The treatment system of claim 1, further comprising a control device mounted on the housing, the control device for activating at least one of the crusher and the compactor.

4. The treatment system of claim 3, wherein the control device is for activating only one of the crusher and the compactor at once.

5. The treatment system of claim 4, further comprising at least two bins, each bin for receiving one of the compacted inorganic materials.

6. The treatment system of claim 5, further comprising a waste bin motor for positioning the at least two bins in a position for receiving compacted materials from the compactor means.

7. The treatment system of claim 6, wherein the control device is further for controlling the waste bin motor.

8. The treatment system of claim 1, wherein compactor means comprises compactor jaws.

9. The treatment system of claim 8, wherein the compactor jaws comprise v-shaped protrusions.

10. The treatment system of claim 1, wherein the crusher comprises a cylindrical body and a blade assembly mounted within the cylindrical body, the body having a crusher input for receiving the organic waste and a crusher output for providing an exit to the crushed organic material.

11. The treatment system of claim 10, wherein the blade assembly comprises a rotatable shaft and blades mounted on the rotatable shaft on an angle whereby upon rotation of the rotatable shaft the shaft is pulled into the crusher input and pushed within the body toward the crusher output.

12. The treatment system of claim 1, further comprising a shredder for shredding paper or cardboard, the shredder mounted on the housing.

13. A multi-purpose discarded material treatment system, the discarded material comprises organic waste and inorganic materials, the treatment system comprising:
a. a crusher having crushing means and crusher actuating means, the crushing means adapted to produce, from the organic waste, crushed organic material, the crusher actuating means for connectively controlling the crushing means;
b. a compactor having compactor means and compactor actuating means, the compactor means adapted to produce, from the inorganic materials, compacted inorganic materials, the compactor actuating means for connectively controlling the compactor means;
c. a hydraulic system having hydraulic lines connected to the crusher actuating means and to the compactor actuating means, both the crusher actuating means and the compactor actuating means for being controlled using hydraulic fluid in the hydraulic lines; and
d. a housing on which are mounted the crusher, the compactor and the hydraulic system.

14. The treatment system of claim 13, wherein the housing comprises two housing openings, each housing opening providing a passageway to a corresponding one of the crusher input and the compactor input.

15. The treatment system of claim 13, further comprising a control device mounted on the housing, the control device for activating at least one of the crusher and the compactor.

16. (canceled)

17. (canceled)

18. (canceled)

19. (canceled)

20. The treatment system of claim 13, wherein compactor means comprises compactor jaws.

21. The treatment system of claim 20, wherein the compactor jaws comprise v-shaped protrusions.

22. The treatment system of claim 13, wherein the crusher comprises a cylindrical body and a blade assembly mounted within the cylindrical body, the body having a crusher input for receiving the organic waste and a crusher output for providing an exit to the crushed organic material.

23. The treatment system of claim 22, wherein the blade assembly comprises a rotatable shaft and blades mounted on the rotatable shaft on an angle whereby upon rotation of the rotatable shaft the shaft is pulled into the crusher input and pushed within the body toward the crusher output.

24. The treatment system of claim 13, further comprising a shredder for shredding paper or cardboard, the shredder mounted on the housing.

25.-34. (canceled)
